(19) United States
(12) Patent Application Publication
(10) Pub. No.: US 2019/0140737 A1
(43) Pub. Date: May 9, 2019

(54) A WIRELESS COMMUNICATION SYSTEM

(71) Applicant: BHP BILLITON INNOVATION PTY LTD, BRISBANE (AU)

(72) Inventors: Stephen Vandenberg, Perth (AU); Grant Caffery, Perth (AU); Alan Bye, Perth (AU)

(21) Appl. No.: 16/095,129

(22) PCT Filed: Apr. 28, 2017
(86) PCT No.: PCT/AU2017/050389

§ 371 Date: Oct. 19, 2018

(30) Foreign Application Priority Data
Apr. 29, 2016 (AU) 2016901575

(51) Int. Cl. H04B 7/185; B64C 39/02

(52) U.S. Cl. CPC H04B 7/18504; H04B 7/18521; H04B 7/18513; H04B 7/18563; B64C 2201/022; B64C 39/024; B64C 2201/122; B64C 2201/021; H04B 7/18576

(57) ABSTRACT

The present invention relates to a wireless communication system for controlling one or more remote automated mining assets. The system includes a high-altitude platform including at least one high altitude communication apparatus, and for communicating control messages for the mining assets. A low-altitude platform includes at least one low altitude communication apparatus, and is suitable for communicating control messages for the mining assets. Preferably, the high-altitude platform is a long-term communications platform whereas the low-altitude platform is a short-term communications platform that can be more rapidly deployed and flexibly restructured.

### TECHNICAL FIELD

The present invention relates to a wireless communication system for controlling remote automated mining assets.

### BACKGROUND

The reference to any prior art in this specification is not, and should not be taken as an acknowledgement or any form of suggestion that the prior art forms part of the common general knowledge.

Automated mining assets, such as diggers and trucks, are used to conduct mining operations in remote locations where there is no or limited fixed communications infrastructure.

A mobile terrestrial wireless communication system can be used to communicate control messages from a base station to control the remote mining assets. Relocatable trailer mounted wireless communication stations are moved as required to maintain communication between the base station and assets. However, the dynamic nature of the mine topology and associated asset location often undesirably results in communication black spots. Furthermore, the relocation of the communication stations also presents a safety risk to drivers.

There is a need for an improved wireless communication system for controlling remote automated mining assets.

### SUMMARY OF THE INVENTION

According to one aspect of the present invention, there is provided a wireless communication system for controlling one or more remote automated mining assets, the system including:

a high-altitude platform including at least one high altitude communication apparatus, and for communicating control messages for the mining assets; and
a deployable low-altitude platform including at least one low altitude communication apparatus, and for communicating control messages for the mining assets.

The low-altitude communication apparatus may include an unmanned aerial vehicle (UAV), or an autonomous ground vehicle. The high-altitude platform may be a long-term platform. Advantageously, the long-term high-altitude platform may provide wide communications coverage and longer endurance. The low-altitude platform may be a short-term platform. In contrast, the short-term low-altitude platform may be rapidly deployed and flexibly restructured to accommodate for high or unexpected communication demand in localized areas. In the event that the low-altitude platform requires recharging, the somewhat inflexible high-altitude platform may ensure that communications with the assets is maintained without blackspots or the need to relocate terrestrial communication stations.

There may be a tradeoff between coverage and platform performance. Elaborating further, a higher platform may result in greater communication coverage. But, a higher platform may also result in narrower communication bandwidth and higher communication latency (delay). Preferably, a higher one of the platforms results in: greater communication coverage, narrower communication bandwidth or higher communication latency than a lower one of the platforms.

The high altitude communication apparatus may include a balloon or a pseudo-satellite. The high altitude platform may communicate directly with the low altitude platform, a satellite platform and a terrestrial platform.

The UAV may operate between several hundred meters to several kilometers. The UAV may include a drone. The UAV may provide line of sight (LOS) communication. The low altitude platform may communicate directly with the high altitude platform and/or a terrestrial platform.

The system may further include a satellite platform including at least one satellite located above the high altitude platform, and for communicating control messages for the mining assets. The satellite platform may communicate directly with the high altitude platform and/or a terrestrial platform.

The system may further include a terrestrial platform. The terrestrial platform may include the mining assets. The terrestrial platform may include mobile ground vehicles, and for communicating control messages for the mining assets. The ground vehicles may include unmanned autonomous ground vehicles (UGVs). The ground vehicles may include trailer mounted communication stations. The terrestrial platform may communicate directly with the low altitude platform, the high altitude platform and/or the satellite platform.

Each of the platforms may wirelessly communicate control messages either directly or indirectly to the mining assets. Preferably, a break in any single communication link between two platforms will not result in a communications breakdown whereby the control messages can still be relayed between any platforms. Furthermore, each platform may capture data.

The platforms may be layered. The high-altitude platform may be located beneath a satellite platform. The satellite platform may be located at or beyond the thermosphere. The high-altitude platform may be beyond several kilometers high, or intersect the outer troposphere or the stratosphere. The satellite platform may be in place for longer than the long-term high-altitude platform. The high-altitude platform may be in place for longer than the low-altitude platform.

According to another aspect of the present invention, there is provided a wireless communication method for controlling one or more remote automated mining assets, the method including:

providing a high-altitude platform including at least one high altitude communication apparatus, and for communicating control messages for the mining assets; and

deploying a low-altitude platform including at least one low altitude communication apparatus, and for communicating control messages for the mining assets.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1a is a schematic view of a wireless communication system for controlling remote automated mining assets in accordance with an embodiment of the present invention; and

FIG. 1b is a block diagram showing the layered communication platforms of the communication system of FIG. 1a.

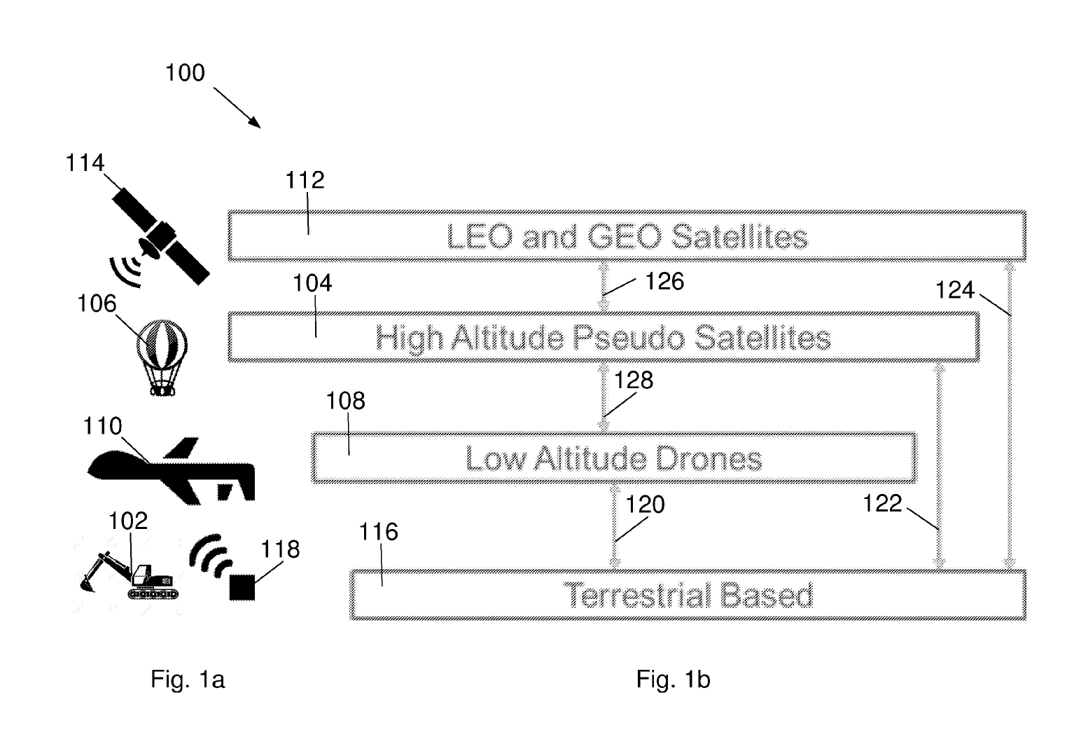

### DETAILED DESCRIPTION OF PREFERRED EMBODIMENTS

According to an embodiment of the present invention, there is provided a wireless communication system 100 for controlling remote automated mining assets 102. The mining assets include 102 diggers for digging material and trucks for transporting the dug material.

The system 100 includes a long-term (e.g. hours to weeks) high-altitude platform 104 including at least one high-altitude communication apparatus 106. The high-altitude communication apparatus typically includes a balloon or a pseudo-satellite. The high-altitude platform 104 is in the outer troposphere or the stratosphere, beyond several kilometers high, and is suitable for communicating control messages for controlling the mining assets 102.

The system 100 further includes a deployable short-term (e.g. minutes to hours) low-altitude platform 108 including at least one low altitude unmanned aerial vehicle (UAV) 110. The UAV 110 is typically a drone operating beneath the high-altitude platform 104, between several hundred meters to several kilometers high. The UAV 110 provides line of sight (LOS) communication, and is suitable for communicating control messages for controlling the mining assets 102.

Advantageously, the long-term high-altitude platform 104 provides wide communications coverage and longer endurance. In contrast, the short-term low-altitude platform 108 can be rapidly deployed and flexibly restructured to accommodate for high or unexpected communication demand in localized areas. In the event that the low-altitude platform 108 requires recharging, the somewhat inflexible high-altitude platform 104 ensures that communications with the assets 102 is maintained without blackspots or the need to relocate terrestrial communication stations.

The system 100 further includes an uppermost satellite platform 112. The long-term high-altitude platform 104 is located substantially beneath the satellite platform 112 which, in turn, is located at or beyond the thermosphere. The permanent (e.g. years to decades) satellite platform 112 includes at least one low earth orbit (LEO) or geosynchronous (GEO) satellite 114 located above the high-altitude platform 104. The satellite platform 112 is suitable for communicating control messages for the mining assets 102.

The system 100 further includes a lowermost terrestrial platform 116 for land bound vehicles. In particular, the transient terrestrial platform 116 includes the mining assets 102 which can communicate among each other, as well as mobile ground vehicles 118 with trailer mounted wireless communication stations. The ground vehicles 118 include unmanned ground vehicles (UGVs) which are far safer than manned vehicles operating in the same environment as the automated mining assets 102. The terrestrial platform 116 is suitable for communicating control messages for the mining assets 102.

Each of the layered deployable platforms 104, 108, 112, 116 can wirelessly communicate control messages from a base station, either directly or indirectly, to the mining assets 102. A break in any single communication link 120-128 between two platforms will not result in a communications breakdown whereby the control messages can still be relayed between any of the platforms 104, 108, 112, 116. Furthermore, each platform 104, 108, 112, 116 can capture and transmit data relating to the mine environs. In particular, various data patterns can be captured that may be of different volumes and time criticalities which set the requirement for system bandwidth, latency and availability.

The terrestrial platform 116, including the assets 102, can communicate directly with the low altitude platform 108, the high altitude platform 104 and the satellite platform 112 via respective communication links 120, 122, 124. The satellite platform 112 can communicate directly with the high altitude platform 104 and the terrestrial platform 116 via respective communication links 126, 124. The high altitude platform 104 can communicate directly with the low altitude platform 108, the satellite platform 112 and the terrestrial platform 116 via respective communication links 128, 126, 122. The low altitude platform 108 can communicate directly with the high altitude platform 104 and the terrestrial platform 116 via respective communication links 128, 120.

There is a tradeoff between coverage and platform performance. Elaborating further, a higher platform results in greater communication coverage. Accordingly, the coverage increases from the terrestrial platform 116 up to the satellite platform 112. But, a higher platform also results in narrower communication bandwidth and higher communication latency or delay. Accordingly, the bandwidth increases from the satellite platform 112 to the terrestrial platform 116. Further, the communication latency decreases from the satellite platform 112 to the terrestrial platform 116. A higher one of the platforms results in: greater communication coverage, narrower communication bandwidth and higher communication latency than a lower one of the platforms.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A wireless communication system for controlling one or more remote automated mining assets, the system including:
a high-altitude platform including at least one high altitude communication apparatus, and for communicating control messages for the mining assets; and
a deployable low-altitude platform including at least one low altitude communication apparatus, and for communicating control messages for the mining assets.

2. A system as claimed in claim 1, wherein the high-altitude platform is a long-term platform whereas the low-altitude platform is a short-term platform.

3. A system as claimed in claim 1, wherein the high-altitude platform results in: greater communication coverage, narrower communication bandwidth or higher communication latency than the low-altitude platform.

4. A system as claimed in claim 1, wherein the high altitude communication apparatus includes a balloon or a pseudo-satellite, the high altitude platform communicating directly with the low altitude platform, a satellite platform and/or a terrestrial platform.

5. (canceled)

6. A system as claimed in claim 1, wherein the low-altitude communication apparatus includes an unmanned aerial vehicle (UAV), or an autonomous ground vehicle.

7. A system as claimed in claim 6, wherein the UAV operates between several hundred meters to several kilometers, the UAV including a drone and providing line of sight (LOS) communication.

8-9. (canceled)

10. A system as claimed in claim 1, wherein the low altitude platform communicates directly with the high altitude platform and/or a terrestrial platform.

11. A system as claimed in claim 1, further including a satellite platform including at least one satellite located above the high altitude platform, and for communicating control messages for the mining assets, the satellite platform communicating directly with the high altitude platform and/or a terrestrial platform.

12. (canceled)

13. A system as claimed in claim 1, further including a terrestrial platform.

14. A system as claimed in claim 13, wherein the terrestrial platform includes the mining assets.

15. A system as claimed in claim 13, wherein the terrestrial platform includes mobile ground vehicles that communicate control messages for the mining assets.

16. A system as claimed in claim 15, wherein the ground vehicles include unmanned autonomous ground vehicles (UGVs).

17. A system as claimed in claim 15, wherein the ground vehicles include trailer mounted communication stations.

18. A system as claimed in claim 13, wherein the terrestrial platform communicates directly with the low altitude platform, the high altitude platform and/or a satellite platform.

19. A system as claimed in claim 1, wherein each of the platforms wirelessly communicate control messages either directly or indirectly to the mining assets, wherein a break in any single communication link between two platforms will not result in a communications breakdown whereby the control messages can still be relayed between any platforms.

20-21. (canceled)

22. A system as claimed in claim 21, wherein the high-altitude platform is located beneath a satellite platform, the satellite platform, being in place for longer than the high-altitude platform.

23. A system as claimed in claim 22, wherein the satellite platform is located at or beyond the thermosphere.

24. (canceled)

25. A system as claimed in claim 1, wherein the high-altitude platform is in place for longer than the low-altitude platform.

26. A system as claimed in claim 1, wherein the high-altitude platform is beyond several kilometers high, or intersects the outer troposphere or the stratosphere.

27. A wireless communication method for controlling one or more remote automated mining assets, the method including:
providing a high-altitude platform including at least one high altitude communication apparatus, and for communicating control messages for the mining assets; and
deploying a low-altitude platform including at least one low altitude communication apparatus, and for communicating control messages for the mining assets.
